(19) United States
(12) Patent Application Publication
(10) Pub. No.: US 2006/0030227 A1
(43) Pub. Date: Feb. 9, 2006

(54) Intumescent flame retardent compositions

(76) Inventors: George Hairston, Spartanburg, SC (US); John Burns, Simpsonville, SC (US); Warren Stidham, Cohutta, GA (US); Kim Van Voorhis, Rutherfordton, NC (US)

Correspondence Address: James M. Robertson, 233 S. Pine Street, Spartanburg, SC, 29302, US

(21) Appl. No.: 10/912,868

(22) Filed: Aug. 6, 2004

(51) Int. Cl. B32B 27/04; B32B 5/18

(52) U.S. Cl. 442/136; 442/139; 442/141; 442/144; 442/145; 442/146; 442/221; 442/315

(57) ABSTRACT

Intumescent compositions which provide enhanced levels of flame resistance and which are suitable for topical and/or infused application to articles to be protected. The intumescent compositions are characterized by substantial pliability upon topical application to and/or infusion or blending within a material to be protected.

### TECHNICAL FIELD

The present invention relates generally to flame retardancy compositions of intumescent character and more particularly to a composition of intumescent character including halogenated oils or waxes disposed in coated and/or infused relation across flexible substrates including fabrics, foams, crumb rubber and the like, to provide enhanced flammability resistance. Compositions according to the present invention provide relatively low increases in stiffness while nonetheless providing enhanced resistance to flammability. Moreover, such compositions are not reliant on bromine or brominated compounds for flame retardancy. In addition, such compositions are substantially insoluble in aqueous environments thereby permitting articles incorporating such compositions to be laundered without substantial degradation of flame resistance levels.

### BACKGROUND OF THE INVENTION

Intumescent compositions, which react on contact to flame by charring and swelling, are well known. When such compositions are subjected to flame, charring and swelling occurs forming layers which may be filled with non-flammable gasses created during the intumescent reaction. The layers so formed thus provide a degree of insulation against continued combustion. Typical applications for such intumescent compositions have included building material and paints to prevent the spread of fire and structural damage.

It has also been proposed to use intumescent coatings across fabric substrates to provide a degree of thermal protection to the fabric substrates. By way of example only, such uses are described in U.S. Patent application US 2003/0082972 A1 in the name of Monfalcone III et. al. the contents of which are hereby incorporated by reference as if fully set forth herein. As best understood, the flame retardant compositions which have been utilized in the past have been standard commercial intumescent compositions. While such compositions may provide enhanced levels of flame resistance, such traditional compositions may in some instances, also provide enhanced levels of stiffness to the fabric or other substrate. In addition, as best understood, many prior intumescent compositions incorporate compounds of bromine and thus may be undesirable to some users on grounds of health and environmental concerns.

### SUMMARY OF THE INVENTION

The present invention provides advantages and alternatives over the prior art by providing intumescent compositions which provide enhanced levels of flame resistance and which are suitable for topical and/or infused application to articles to be protected.

According to one potentially preferred aspect of the invention, the intumescent composition is characterized by substantial pliability upon topical application to and/or infusion or blending within a material to be protected. According to one particularly preferred embodiment, such retained pliability is enhanced by utilization of liquid phase halogenated paraffin oils substantially free of brominated compounds in at least partial replacement for traditional solid phase paraffin or other resinous material.

According to still a further potentially preferred embodiment, liquid phase chlorinated paraffin oil is used in place of solid phase resinous material and in combination with an aqueous insoluble phosphorus-releasing catalyst so as to promote pliability while nonetheless preventing dissolution during washing or other cleaning procedures.

Additional aspects and advantages of the invention will be set forth in the description which follows in relation to certain potentially preferred embodiments, procedures, and practices and/or will be realized of those of skill in the art upon practice of such embodiments, procedures, and practices. However, it is to be understood that in no case is the invention to be limited to any such embodiments, procedures, and practices as may be specifically described. On the contrary, it is intended that the invention shall instead refer to all alternatives, modifications, and equivalents as may embrace the principles of the invention within the true scope and spirit thereof.

### BRIEF DESCRIPTION OF THE DRAWINGS

The following drawings which are incorporated in and which constitute a part of this specification illustrate various exemplary practices for application of flame retardant compositions to substrates wherein:

FIG. 1 illustrates an exemplary coating line for topical surface film application of a relatively high viscosity flame retardant composition in accordance with the present invention across a substrate surface; and

FIG. 2 illustrates an exemplary coating line for forced infusion of a relatively low viscosity flame retardant composition in accordance with the present invention into the body of a substrate.

While the present invention has been illustrated and generally described above and will hereinafter be described in conjunction with certain potentially preferred embodiments, procedures, and practices, it is to be understood that in no case is the invention to be limited to such illustrated and described embodiments, procedures, and practices. On the contrary, it is intended that the present invention shall extend to all alternatives, modifications, and equivalents as may embrace the principles of the present invention within the true scope and spirit thereof.

### DESCRIPTION OF PREFERRED EMBODIMENTS

Reference will now be made to several exemplary and potentially preferred embodiments and procedures in accordance with the present invention. It is to be understood that all embodiments and procedures as may be described are exemplary and explanatory only and should in no event be viewed as being restrictive of the invention as claimed.

The intumescent compositions according to the present invention preferably incorporate the following basic constituents: (i) a phosphorous-releasing catalyst: (ii) a carbon donor: (iii) a blowing agent: and (iv) a halogen donor in the form of a liquid phase oil. It is contemplated that the composition may also include various binders, dispersants and thickeners as may be desired to promote processing and application.

As will be appreciated, it is contemplated that the actual constituents may be selected from a relatively wide range of alternatives. In this regard, exemplarily contemplated phosphorous-releasing catalysts may include ammonium polyphosphate, diammonium polyphosphate, phosophated alcohols, phosophated glycols, potassium tripolyphosphate or combinations thereof. In the event that the treated article is to be subjected to laundering such as clothing, bedding or the like, the phosphorous-releasing catalyst will preferably be substantially insoluble in water thereby reducing degradation effects from cleaning. In this regard, mono-ammonium polyphosphate may be particularly preferred for such applications.

In the potentially preferred embodiments of the present invention, the carbon source is preferably pentaerythritol, dipentaerythritol (DPE), or a combination thereof. Such materials give rise to bridging between voids formed by gas evolution during the flame-activated intumescent reaction.

The blowing agent is preferably melamine, urea, dicyandiamide or combinations thereof. In the event that the flame retardant composition is to be intermixed with a foam-forming base chemical such as urethane-forming MDI or TDI it is contemplated that the phosphorous-releasing catalyst is preferably a melamine coated ammonium polyphosphate or the like. It has been found that such materials avoid interference with the foam-forming polyol constituents while nonetheless still providing flame resistance.

As previously indicated, according to one potentially preferred practice, the halogen donor in the intumescent compositions of the present invention is preferably in the form of liquid halogenated oil. Such materials are preferably present at levels in the range of about 3 to about 20 percent by weight of the finished composition. Potentially desirable halogenated oils are characterized by exhibiting a liquid phase consistency with a viscosity of not greater than about 30,000 centipoise at room temperature (72 degrees F.). Non-brominated halogen donors such as chlorinated paraffin oils may be particularly preferred so as to avoid any negative environmental or health effects that may be associated with bromine. Past known flame retardant compositions have typically incorporated brominated constituents as a key component. However, it has been found that the substitution of a non-brominated halogen oil nonetheless provides excellent flammability resistance to an intumescent system while being substantially free of bromine.

It is believed that the halogenated oils act as a plasticizer within latex or other binder thereby softening the final composition after application to or infusion into an article to be protected. Thus, the final article is not stiffened to an excessive degree. Depending upon the final contemplated use and application equipment being utilized, it is contemplated that the applied flame retardant composition may be characterized by a wide range of viscosities ranging from about 1,000 centipoise or less to about 20,000 centipoise. Viscosity may be controlled by the selective addition of thickening agents as will be described further hereinafter.

The flame retardant compositions may be applied across and/or forced into a flexible substrate such as a fabric, foam, plastic article (including polymeric fibers) crumb rubber or the like by coating practices as are well known to those of skill in the art. When applied to a textile substrate, it is contemplated that the flame retardant compositions may be particularly desirable for use on substrates which have a relatively high cellulosic content due to the retained softness in such substrates following application. By way of example only, and not limitation, cellulosic constituents may include cotton, rayon and the like. It is contemplated that the flame retardant compositions of the present invention may provide particular benefits to fabrics designed with overall cellulose fiber contents of about 30% or greater. This benefit is a result of the fact that such fabrics are typically intended for uses in which retained softness is a desirable atribute. Thus, a treatment that does not substantially increase stiffness may be particularly beneficial. Of course, the treatment compositions may also be used on fabrics without substantial cellulosic contents if desired.

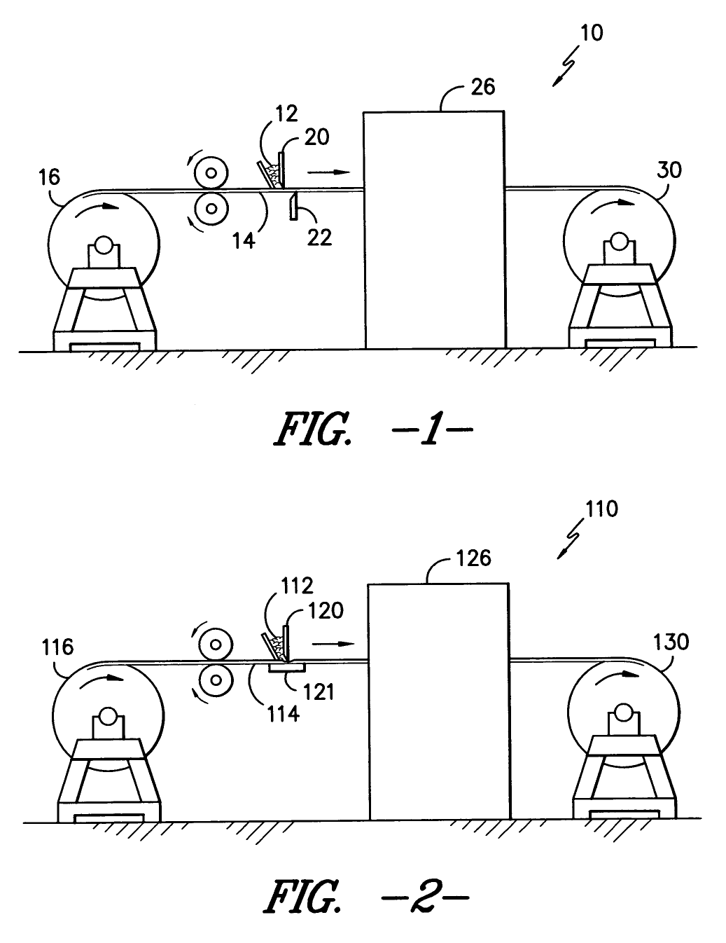

By way of example only, and not limitation, in FIG. 1 there is illustrated a coating line 10 for application of a flame retardant composition 12 in surface film-forming relation across a substrate 14 such as a foam, rubber sheeting, woven fabric, knit fabric, non-woven fabric or the like. As illustrated, in such a coating line the substrate 14 is passed from a supply roll 16 into surface contacting relation with an accumulated mass of the flame retardant composition 12 held upstream of a coating knife 20. A tension bar 22 is disposed below the substrate 14 downstream of the coating knife 20 such that the substrate is held in tension at a controlled distance below the edge of the coating knife 20. Thus a controlled thickness of the flame retardant composition is spread across the substrate 14. The substrate 14 with applied flame retardant composition 12 is then passed through an oven 26 maintained at about 300° F. to cure the binder in the flame retardant composition. The coated substrate is then passed to a collection roll 30 for subsequent use.

In FIG. 2 there is illustrated a coating line 110 for surface infusion of a flame retardant composition 112 into a substrate 114 such as a porous foam, textile fabric, crumb rubber or the like. As illustrated, in such a coating line the substrate 114 is passed from a supply roll 116 into surface contacting relation with an accumulated mass of the flame retardant composition 112 held upstream of a coating knife 120. A support plate 121 is disposed below the substrate 114 such that the coating knife 120 and the support plate 121 form a pinch point of defined thickness for passage of the substrate 114. The thickness of the pinch point is preferably such that a potion of the flame retardant composition 112 is forced below the surface and into the interior of the substrate 114. This results in an infused zone of flame retardant composition 112 below the surface of the substrate 114 with a thin film of the flame retardant composition 112 at the surface. The infused zone of flame retardant composition 112 may extend partially or completely across the thickness of the substrate 114. The substrate 114 with applied flame retardant composition 112 is then passed through an oven 126 maintained at about 300° F. to cure the binder in the flame retardant composition. The infused substrate is then passed to a collection roll 130 for subsequent use.

The invention may be further understood through reference to the following non-limiting examples:

### EXAMPLE 1

A flame retardant composition having a room temperature viscosity in the range of about 3,000 centipoise to about 5,000 centipoise was produced from the constituents as set forth in Table 1 wherein all percentages are by weight.

TABLE 1
Standard Viscosity Composition

| ITEM | PERCENT (%) |
|---|---|
| PREMIX | |
| Water | 28.877 |
| Naphthalene Sulfonate | 0.8 |
| Polyoxyethylene Tridecyl Alcohol | 0.72 |
| Ammonium Casein | 4.28 |
| Surfactant | 1.4 |
| Melamine | 8.1 |
| Mono-Ammonjum Polyphosphate | 20.21 |
| Pentaerythritol | 8.1 |
| Zinc Borate | 5.69 |
| Antimony Oxide | 5.21 |
| Urea | 0.8 |
| Sulfonated 2 Ethyl Hexanol, 60% | 0.27 |
| Triethanolamine | 0.68 |
| Aluminum Trihydrate | 12.19 |
| Karaya Gum Solution, 5% | 2.67 |
| TOTAL | 100 |
| FINISHED FORMULA | |
| Premix from above | 68.36 |
| Acrylic Latex | 19.27 |
| Water | 3.04 |
| Chlorinated Paraffin oil | 8.88 |
| Aqua Ammonia | 0.29 |
| Final Thickener | 0.16 |
| TOTAL | 100 |

According to the practice utilized, the constituents forming a premix were blended in an attritor to effect both blending and particle size reduction until all solids were below about 150 microns. As will be appreciated, the premix contained a carbon donor in the form of pentaerythritol as well as a blowing agent in the form of melamine in combination with urea. Various constituents were also added to aid in processing and to enhance the suitability for substrate application. In particular, naphthalene sulfonate was added as a dispersant. Polyoxyethylene tridecyl alcohol with 6 mole equivalents of ethoxilation was added as a wetting agent. Ammonium Casein was added as a thickener to enhance body and retain solid additives in suspension so as to promote enhanced shelf life. The surfactant utilized was supplied by Air Products Corporation under the trade designation Surfynol CT-131. Zinc Borate and Antimony Oxide were added to enhance resistance to post-combustion after glow and to enhance resistance to vertical burning respectively. Sulfonated 2 Ethyl Hexanol was added to aid in fluidity. Triethanolamine is a base used to control pH and to aid in stability. The Aluminum Trihydrate is believed to reduce surface tack while also promoting flame resistance by releasing water when subjected to heat. Finally, The Karaya Gum Solution was added as a thickener. Of course, it is to be understood that the actual additives and amounts may be subject to a wide range of variations depending upon the desired character and processing conditions. By way of example, it is contemplated that the Zinc Borate and/or Antimony Oxide may be eliminated if post-combustion after glow and enhanced resistance to vertical burning is not of substantial concern in the contemplated environment of use.

Following formation of the premix in the attritor the premix was thereafter intermixed with a latex carrier or binder. One potentially preferred latex binder is a low T_{g} acrylic latex available from Adhesive Coatings Technologies in Dalton, Ga. under the trade designation BSD-315. It is also contemplated that other binder materials such as vinyl acetate-ethylene copolymers and the like may be utilized if desired. A halogen donating chlorinated paraffin oil was added during the mixing process. By way of example only, and not limitation, one such chlorinated paraffin oil which is believed to be particularly suitable is marketed under the trade designation KLORO 6001 by Dover Chemical Corporation. Finally, in order to achieve the desired viscosity, aqua ammonia was added to raise the pH to above about 8.0 followed by addition of a long chain acid thickener such as Drewtix 53-L marketed by Drew Chemical which is activated at the pH levels realized through the addition of the aqua ammonia.

The resultant composition was characterized by a viscosity in the range of about 3,000 to about 5,000 centipoise and was suitable for application to substrates using standard coating techniques including knife coaters, roll coaters and the like as well as by standard saturation techniques such as pan saturation and so called “dip and nip” application in which a substrate is passed through a bath and then through a compressive nip roll.

The resultant composition was deposited across a greige plain woven fabric having a weight of about 3 ounces per square yard at a coating weight of about 4.5 ounces per square yard using a knife coater. The fabric had a construction of 78 warp yarns per inch×54 fill yarns per inch. The warp yarns were 100% cotton with a yarn count of 35/1. The fill yarns were 50% polyester, 50% cotton with a yarn count of 35/1. No scouring, bleaching, or framing of the base fabric was done prior to coating. The coated fabric was then dried at a temperature of about 300° F. to cure the binder.

The base fabric (without the coating) and the coated fabric were measured for stiffness in accordance with ASTM D 1388, Standard Test Method for Stiffness of Fabrics, Option A, Cantilever Test. This test employs the principle of cantilever bending of the fabric under its own mass. The cantilever test is conducted by sliding the specimen at a specified rate in a direction parallel to its long dimension, until its leading edge projects from the edge of a horizontal surface. The length of the overhang is measured when the tip of the specimen is depressed under its own mass to the point where the line joining the tip to the edge of the platform makes a 41.5 degree angle with the horizontal. From this measured length, the bending length and flexural rigidity are calculated.

For the ASTM D 1388 Cantilever Test, four specimens each in the warp and fill direction of the woven fabric, coated and uncoated, were tested. The test results indicated that the average bending length of the coated specimens was 36 percent lower than that of the uncoated greige fabric when averaged for warp and fill directions. Flexural rigidity was reported for the coated sample at 27 percent less than for the uncoated greige fabric when averaged for warp and fill directions. The test data thus shows that the present invention does not contribute to increased stiffness when coating under the described conditions and tested in accordance with ASTM D 1388.

The coated and uncoated fabrics were subjected to flame tests in which the samples were exposed to a large open flame presented by a propane-fueled burner with multiple orifices, simulating the NIST (National Institute of Standards and Technology) burner apparatus utilized in large-scale mattress flammability testing as set forth in California department of consumer affairs Bureau of Home Furnishings and Thermal Insulation Technical Bulletin 603 (incorporated by reference). The coated fabric did not burn after an exposure time of 70 seconds while the uncoated fabric exhibited substantial combustion.

### EXAMPLE 2

A low viscosity flame retardant composition characterized by a room temperature viscosity of about 1,000 to about 2,000 centipoise was produced utilizing the formulation as set forth in Table 2.

TABLE 2
Low Viscosity Composition

| ITEM | PERCENT (%) |
|---|---|
| PREMIX | |
| Water | 28.877 |
| Naphthalene Sulfonate | 0.8 |
| Polyoxyethylene Tridecyl Alcohol | 0.72 |
| Ammonium Casein | 4.28 |
| Surfactant | 1.4 |
| Melamine | 8.1 |
| Mono-Ammonium Polyphosphate | 20.21 |
| Pentaerythritol | 8.1 |
| Zinc Borate | 5.69 |
| Antimony Oxide | 5.21 |
| Urea | 0.8 |
| Sulfonated 2 Ethyl Hexanol, 60% | 0.27 |
| Triethanolamine | 0.68 |
| Aluminum Trihydrate | 12.19 |
| Karaya Gum Solution, 5% | 2.67 |
| TOTAL | 100 |
| FINISHED FORMULA | |
| Premix from above | 70.55 |
| Chlorinated Paraffin Oil | 9.2 |
| Acrylic Latex | 19.95 |
| Aqua Ammonia | 0.3 |
| TOTAL | 100 |

As can be seen, the premix in the low viscosity composition is identical to the premix for the higher viscosity composition previously described. Likewise, the processing techniques are also identical. However, in preparation of the finished formula the thickener is eliminated thus yielding a much lower viscosity product which may be more suitable for applications such as infusion into the upper surface of a flexible foam, rubber, molded plastic article (such as fiber) or the like wherein penetration is at least partially dependant upon capillary action and/or physically forcing the flame retardant composition into the article to be protected.

In order to evaluate flammability protection the low viscosity flame retardant composition was surface impregnated in a ½ inch thick layer of urethane foam in a manner as described above in relation to FIG. 2. The coating was applied at 10 ounces per square yard dry coating weight and impregnated to a depth of about 3/16 inches. The resulting foam was subjected to flame tests in which the samples were exposed to a large open flame presented by a propane-fueled burner with multiple orifices, simulating the NIST burner apparatus utilized in the large-scale mattress flammability testing as set forth in California Department of Consumer Affairs Bureau of Home Furnishings and Thermal Insulation Technical Bulletin 603 (incorporated by reference). The treated foam passed the flammability test even when exposed to flame for time in excess of 200 seconds. An untreated foam specimen burned vigorously.

Of course it is to be understood that an intermediate viscosity composition may also be produced by using a percentage of thickener which is less than that of Table 1 but greater than 0. Likewise, higher viscosities up to about 20,000 centipoise may be achieved by the addition of thickener at levels greater than that of Table 1.

### COMPARATIVE EXAMPLES

The character of pliable textile substrates treated with intumescent flame retardant compositions as described above in accordance with the present invention was compared relative to a pliable textile substrate treated with an alternative intumescent flame retardant composition. The textile substrate treated with the alternative intumescent flame retardant composition was a sample of a commercial product currently being marketed by the company that is believed to own rights to US patent application 2003/0082972A1 to Montfalcone, Ill. for use in providing flame resistance within mattress environments. Thus, the sample incorporating the alternative flame retardant composition is marketed by an entity familiar with intumescent coating options. Moreover, since the sample is of an actual commercial product, it is believed that the product has likely been the subject of optimization efforts intended to produce desirable tactile and stiffness characteristics for use in a mattress and which would not use unnecessarily excessive levels of coating compositions. As best understood, the product is intended for use at a position below the mattress surface in overlying relation to a foam backing. The textile substrate appeared to be a warp knit fabric provided with a coating having intermittent pinhole voids across the surface, although specific construction details could not be determined with certainty.

For purposes of comparison, a pliable textile sample of greige plain woven fabric as described in Example 1 above having a weight of about 3 ounces per square yard was coated with an intumescent flame retardant composition at a coating weight of about 4.5 ounces per square yard using a knife coater. As previously indicated, the fabric had a construction of 78 warp yarns per inch×54 fill yarns per inch. The warp yarns were 100% cotton with a yarn count of 35/1. The fill yarns were 50% polyester, 50% cotton with a yarn count of 35/1. The flame retardant composition was as described in Example 1 above. No scouring, bleaching, or framing of the base fabric was done prior to coating. The coated fabric was then dried at a temperature of about 300° F. to cure the binder. As indicated in Example 1 above, such coated fabric exhibited flame resistance characteristics such that samples did not burn after an exposure time of 70 seconds when exposed to a large open flame presented by a propane-fueled burner with multiple orifices simulating the burner apparatus utilized in the large-scale mattress flammability testing as set forth in California Department of Consumer Affairs Bureau of Home Furnishings and Thermal Insulation Technical Bulletin 603.

For purposes of further comparison, a pliable textile sample of circular knit fabric having a weight of about 3.3 ounces per square yard was coated with an intumescent flame retardant composition at a coating weight of about 5 ounces per square yard using a knife coater. The fabric had a terry knit pattern construction with 17 wales per inch by 24 courses per inch. The yarns used were a blend of about 31% cotton and 69% polyester. The flame retardant composition was as described in Example 1 above. No scouring, bleaching, or framing of the base fabric was done prior to coating. The coated fabric was then dried at a temperature of about 300° F. to cure the binder. Such coated fabric exhibited flame resistance characteristics such that samples did not burn after an exposure time of 70 seconds when exposed to a large open flame presented by a propane-fueled burner with multiple orifices simulating the burner apparatus utilized in the large-scale mattress flammability testing as set forth in California Department of Consumer Affairs Bureau of Home Furnishings and Thermal Insulation Technical Bulletin 603.

In order to evaluate the character of the coated substrates in terms of tactile feel or “hand” and flexibility, equal area samples of the woven fabric and the knit fabric as described above coated with the intumescent flame retardant composition of Example 1 at the identified levels were submitted to a panel of four persons (two male and two female) with no knowledge of intumescent coating compositions along with an equal area sample of the alternative commercial mattress protective textile coated with the alternative intumescent composition. All three samples were unmarked. The panel members were asked to assign comparative rankings to the samples relative to one another for flexability and feel. Available choices for the comparative rankings were “Much Worse”, “Worse”, “Same As”, “Better”; and “Much Better”. The intended use as a barrier fabric within a mattress in overlying relation to a foam interior was explained. The panel members were all non-management employees of a company having rights in the present invention and as such were under a general obligation of confidentiality. None of the panel members had any prior involvement with the present invention. Each of the equal area samples was also weighed to compare the mass per unit area of the products intended for mattress protection. The results of the evaluation are set forth in Table 3 below. The four comparative rankings correspond to the four panel members. The increase in mass per unit area from the wet coating state is due to natural heat shrinkage during curing.

TABLE 3

| | | FLEXIBILITY | FEEL |
|---|---|---|---|
| | | Relative to | Relative to |
| | MASS PER | Current | Current |
| SAMPLE | Unit Area | Commercial | Commercial |
| Current | 8.4 oz/yd2 | Baseline | Baseline |
| Commercial | | | |
| Product | | | |
| Woven | 8.4 oz/yd2 | Much Better | Much Better |
| Substrate | | Much Better | Much Better |
| | | Worse | Worse |
| | | Better | Better |
| Knit Substrate | 8.5 oz/yd2 | Much Better | Much Better |
| | | Much Better | Much Better |
| | | Much Better | Much Better |
| | | Much Better | Much Better |

These results indicate that textile substrates coated with the intumescent flame retardant compositions according to the present invention at levels effective to provide flame protection within a mattress are recognized as being more flexible and with better feel than known alternative commercial intumescent coated materials designed for similar uses. The results indicate that knit substrates may be particularly desirable relative to the commercial alternative product.

As previously indicated, it is contemplated that the intumescent compositions of the present invention may find application in a wide variety of uses. By way of example only, it is contemplated that compositions according to the present invention which incorporate the halogenated oil constituent may be readily used in coated relation to material such as textile fabrics and foams as well as in infused (i.e. saturated) foams wherein the composition is forced to a prescribed depth into the foam following foam formation. It is also contemplated that the compositions of the present invention may be interblended with urethanes, rubbers, and plastics while such materials are in the fluid state to enhance overall flame retardancy.

While the present invention has been described in relation to certain exemplary and potentially preferred embodiments and practices, it is to be understood that such embodiments and practices are illustrative only and that the present invention in no event to be limited thereto. Rather, it is contemplated the modifications and variations will no doubt occur to those of skill in the art upon reading the above description and/or through practice of the invention. It is therefore contemplated and intended that the present invention shall extend to all such modifications and variations as may incorporate the broad concepts of the present invention within the full spirit and scope thereof.

1. A flame retardant composition disposed in coated or infused relation across a flexible substrate to increase flammability resistance of the substrate, wherein the flame retardant composition is substantially free of bromine and comprises a blend comprising: a phosphorous releasing catalyst; a carbon donor; a blowing agent; and a halogen donor in the form of a chlorinated paraffin oil blended within a latex base, wherein the chlorinated paraffin oil is present at a level in the range of 3 to 20 percent by weight of the flame retardant composition, and wherein the chlorinated paraffin oil is characterized by being in a liquid phase and having a viscosity of not greater than 30,000 centipoise at 72 degrees Fahrenheit.

2. The invention as recited in claim 1, wherein the phosphorous releasing catalyst is substantially insoluble in water.

3. The invention as recited in claim 2, wherein the phosphorous releasing catalyst is mono-ammonium polyphosphate.

4. The invention as recited in claim 1, wherein the carbon donor is selected from the group consisting of pentaerythritol, dipentaerythritol and combinations thereof.

5. The invention as recited in claim 1, wherein the blowing agent is selected from the group consisting of melamine, urea, dicyandiamide and combinations thereof.

6. The invention as recited in claim 1, wherein the latex base comprises an acrylic latex.

7. The invention as recited in claim 1, wherein the phosphorous releasing catalyst is mono-ammonium polyphosphate, wherein the carbon donor is selected from the group consisting of pentaerythritol, dipentaerythritol and combinations thereof, and wherein the blowing agent is selected from the group consisting of melamine, urea, dicyandiamide and combinations thereof.

8. The invention as recited in claim 1, wherein the flame retardant composition is characterized by a viscosity of 3,000 to 5,000 centipoise.

9. The invention as recited in claim 1, wherein the flame retardant composition is characterized by a viscosity of 1,000 to 2,000 centipoise.

10. A flame retardant composition of intumescent character disposed in coated or infused relation across a flexible substrate to increase flammability resistance of the substrate, wherein the flame retardant composition is substantially free of bromine and comprises a blend comprising: at least one of the group consisting of zinc borate and antimony oxide in combination with a phosphorous releasing catalyst; a carbon donor; a blowing agent; and a halogen donor in the form of a chlorinated paraffin oil blended within a latex base, wherein the chlorinated paraffin oil is present at a level in the range of about 3 to about 20 percent by weight of the flame retardant composition, and wherein the chlorinated paraffin oil is characterized by being in a liquid phase and having a viscosity of not greater than 30,000 centipoise at room temperature.

11. The invention as recited in claim 10, further comprising Aluminum Trihydrate.

12. The invention as recited in claim 10 wherein the phosphorous releasing catalyst is substantially insoluble in water.

13. The invention as recited in claim 12, wherein the phosphorous releasing catalyst is mono-ammonium polyphosphate.

14. The invention as recited in claim 10, wherein the carbon donor is selected from the group consisting of pentaerythritol, dipentaerythritol and combinations thereof.

15. The invention as recited in claim 10, wherein the blowing agent is selected from the group consisting of melamine, urea, dicyandiamide and combinations thereof.

16. The invention as recited in claim 10, wherein the flame retardant composition is characterized by a viscosity of 3,000 to 5,000 centipoise.

17. The invention as recited in claim 10, wherein the flame retardant composition is disposed in coated relation across a textile barrier fabric for use in a mattress.

18. The invention as recited in claim 17, wherein the textile barrier fabric is a woven fabric.

19. The invention as recited in claim 17, wherein the textile barrier fabric is a knit fabric.

20. The invention as recited in claim 10, wherein the flame retardant composition is characterized by a viscosity of 1,000 to 2,000 centipoise.

21. The invention as recited in claim 20, wherein the flame retardant composition is disposed in infused relation into a urethane foam.

22. The invention as recited in claim 10, wherein the flame retardant composition is characterized by a viscosity of 8,000 to 10,000 centipoise.

23. The invention as recited in claim 10, wherein the flame retardant composition is characterized by a viscosity of 10,000 to 20,000 centipoise.
